(19) United States
(12) Patent Application Publication
(10) Pub. No.: US 2009/0082525 A1
(43) Pub. Date: Mar. 26, 2009

(54) Metal-resin composite molding and method for manufacturing the same

(75) Inventors: Yoshiki Nakamura, Aichi-ken (JP); Hideyuki Fujiwara, Aichi-ken (JP); Hideyuki Imai, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/232,830

(22) Filed: Sep. 25, 2008

(30) Foreign Application Priority Data
Sep. 26, 2007 (JP) 2007-248896

(51) Int. Cl. C08F 8/42

(52) U.S. Cl. 525/122

(57) ABSTRACT

A metal-resin composite molding is composed of a metal portion and a resin portion. The surface of the metal portion has silanol groups, and the synthetic resin contains an adhesive modifier having adhesive functional groups interacting with the silanol groups. The metal portion and resin portion are bonded together through the interaction between the silanol group and adhesive functional group. The method for manufacturing the metal-resin composite molding includes a step of applying silanol groups to the surface of the metal portion, a step of adding an adhesive modifier having adhesive functional groups interacting with the silanol groups to the synthetic resin thereby producing a molding material, and a step of arranging the metal portion as an insert in a mold for resin molding, melting and forming the molding material in the mold into a resin portion, and at the same time bonding the resin portion to the metal portion through the interaction between the silanol groups and adhesive functional groups.

### BACKGROUND OF THE INVENTION

The present invention relates to a metal-resin composite molding composed of a metal portion formed from a metal bonded to a resin portion formed from a synthetic resin, and a method for manufacturing the metal-resin composite molding.

In recent years, various novel composite materials have been developed, the composite materials being made by bonding various materials together. An example is a composite molding (metal-resin composite molding) composed of a metal portion formed from a metal such as aluminum or copper bonded to a resin portion formed from a synthetic resin such as an engineering plastic. When a metal-resin composite molding is made, for example, a metal portion and a resin portion are bonded together using an adhesive by a method as disclosed in Japanese Laid-Open Patent Publication No. 2002-327070. According to the method, the surface of the metal portion is subjected to pretreatment in order to make the surface of the metal portion suitable for adhesion. As a result of this, adhesion inhibitors are removed from the surface of the metal portion. Subsequently, an adhesive such as an epoxy resin-based or acrylic resin-based type is applied to the pretreated surface of the metal portion. After the adhesive is dried, the metal portion is arranged as an insert in a mold for resin molding. Subsequently, a molding material composed of a synthetic resin is molten in the mold. Then, the molding material molten in the mold is cured thereby forming the resin portion into a predetermined shape. In this way, a metal-resin composite molding, in which a metal portion and a resin portion have been bonded together with an adhesive, is obtained.

However, the technique for manufacturing a metal-resin composite molding using an adhesive requires application and drying of the adhesive on the surface of the metal portion, in addition to the molding of the resin portion. These additional treatments increase the number of working processes.

### SUMMARY OF THE INVENTION

An objective of the invention is to provide a metal-resin composite molding and a method for manufacturing the same, wherein a metal portion and a resin portion are bonded together without using an adhesive.

To achieve the foregoing objective and in accordance with one aspect of the present invention, a metal-resin composite molding composed of a metal portion formed from a metal bonded to a resin portion formed from a synthetic resin is provided. The surface of the metal portion has silanol groups. The synthetic resin contains an adhesive modifier having adhesive functional groups interacting with the silanol groups. The metal portion and the resin portion are bonded together by the interaction between the silanol groups and the adhesive functional groups.

In accordance with another aspect of the present invention, a method for manufacturing a composite molding composed of a metal portion formed from a metal bonded to a resin portion formed from a synthetic resin is provided. The method includes: applying silanol groups to the surface of the metal portion; adding an adhesive modifier having adhesive functional groups interacting with the silanol groups to the synthetic resin thereby producing a molding material; and arranging the metal portion as an insert in a mold for resin molding, melting and forming the molding material in the mold into the resin portion, and at the same time bonding the resin portion to the metal portion through the interaction between the silanol groups and the adhesive functional groups.

### DETAILED DESCRIPTION OF THE PREFERRED EMBODIMENTS

The present invention will be described below in more detail. The metal-resin composite molding of the present invention is a composite molding obtained by bonding a metal portion formed from a metal to a resin portion formed from a synthetic resin without using an adhesive. The following section describes the metal portion and resin portion composing the metal-resin composite molding, and the adhesion between the components.

### <Metal Portion>

The major part of the metal portion excluding the surface is formed into a predetermined shape by machining a metal material. The type of the metal is not particularly limited, and examples thereof include copper, nickel, tin, gold, aluminum, iron, magnesium, stainless steel, chromium, tungsten, zinc, lead, and alloys thereof.

The surface of the metal portion is subjected to ITRO treatment (silicification flame treatment) as described in Japanese Patent No. 3557194. The treatment applies silanol (SiOH) groups to the surface of the metal portion. The silanol groups activate the surface of the metal portion. The details about the ITRO treatment will be described below.

### <Resin Portion>

The resin portion is made by forming a molten molding material into a predetermined shape. The molding material is composed of a synthetic resin as a base material, and an adhesive modifier. The resin portion preferably contains 5 to 40% by weight of the adhesive modifier. If the content of the adhesive modifier is less than 5% by weight, adhesiveness deteriorates. On the other hand, if the content of the adhesive modifier is more than 40% by weight, releasability from the mold during molding deteriorates. The content of the adhesive modifier in the resin portion is more preferably from 10 to 30% by weight.

The synthetic resin is not particularly limited, and examples thereof include engineering plastics such as polyphenylene sulfide (PPS), polyamide (PA), and polybutylene terephthalate (PBT).

Polyphenylene sulfide is a heat-resistant crystalline polymer having a molecular structure composed of alternating phenyl groups (benzene rings) and sulfur (S) atoms. Polyphenylene sulfide features high tensile strength and bending strength. Polyphenylene sulfide is classified into two types: crosslinked type and linear type.

The crosslinked type is a polymer produced through heat treatment in the presence of oxygen during manufacturing of the polymer. The heat treatment increases the molecular weight of the polymer to the intended level. In the crosslinked type, polymer molecules are partially linked together via oxygen to form a two-dimensional or three-dimensional crosslinked structure. Therefore, the crosslinked type has higher stiffness than the linear type at high temperatures. Accordingly, the crosslinked type undergoes less creep deformation and stress relaxation. On the other hand, the linear type is a polymer subjected to no heat treatment during manufacturing of the polymer. Therefore, the polymer molecule of linear type includes no crosslinked structure. The polymer molecule of linear type is in a one-dimensional linear form. In general, the linear type has lower stiffness and slightly higher toughness and elongation than the crosslinked type.

Polyamide is a linear polymer containing a main chain composed of repeating amide bonds (—CONH—). Polyamide features, for example, excellent impact resistance and chemical resistance, and a relatively high deflection temperature under load. Examples of polyamide (PA) include polyamide 6 (PA 6), polyamide 66 (PA 66), polyamide 11 (PA 11), polyamide 12 (PA 12), and aromatic polyamide (aramid resin).

Polybutylene terephthalate is a thermoplastic and crystalline polyester-based resin. Polybutylene terephthalate is excellent in, for example, heat resistance, chemical resistance, electrical properties, dimensional stability, and moldability. In order to improve the physical properties of the base material, such as mechanical strength, heat resistance, electrical conductivity, and electrical insulation properties, the molding material may contain, for example, glass fibers or an inorganic filler.

The adhesive modifier has adhesive functional groups which interact with the silanol groups on the surface of the metal portion. Examples of the adhesive functional groups include unsaturated organic acid groups in maleic anhydride, phthalic anhydride, acrylic acid, maleic acid, and itaconic acid, and epoxy groups and glycidyl groups.

Any type of adhesive modifier may be used as long as it contains adhesive functional groups, and is evenly miscible with a base material. Examples of the adhesive modifier include polyethylene (PE) or a graft copolymer composed of polyethylene as the main chain and a styrenic polymer as the side chain, the graft copolymer being modified with an epoxy group or glycidyl group, and polyethylene modified with maleic anhydride. The content of the adhesive functional groups in the base material and adhesive modifier is preferably from 0.5 to 5% by weight. If the content of the adhesive functional groups is less than 0.5% by weight, the adhesiveness deteriorates. On the other hand, if the content of the adhesive functional groups is more than 5% by weight, releasability from the mold during molding deteriorates. The content of the adhesive functional groups is more preferably from 1 to 3% by weight. The adhesive functional groups may be directly grafted to the base material, or applied thereto through the modification of a polymer end during polymerization.

### <Adhesion>

In the metal-resin composite molding, the metal portion and resin portion are strongly bonded together. The adhesion depends on the interaction between the silanol groups on the surface of the metal portion and the adhesive functional groups on the resin portion.

The interaction refers to the attraction between the molecules, atoms, and electrons at the adhesive interface between the metal portion and resin portion. The interaction may be primary bonding involving transfer or sharing of electrons between the silanol groups and adhesive functional groups (e.g., ionic bond or covalent bond). Alternatively, the interaction may be secondary bonding (e.g., van der Waals bond or hydrogen bond) wherein the silanol groups and adhesive functional groups attract each other due to the positive and negative portions caused by the biased electron density within the molecule.

For example, when the adhesive functional groups are epoxy groups (including epoxy groups in glycidyl groups), electrostatic attraction occurs between the oxygen atoms in the epoxy groups and the hydrogen atoms in the silanol groups. More specifically, the oxygen atoms and hydrogen atoms form hydrogen bonds thereby bonding the metal portion to the resin portion.

### <Shape of Metal-Resin Composite Molding>

The shape of the metal-resin composite molding is not particularly limited. For example, the metal-resin composite molding may have a flat shape like, for example, a plate, a sheet, a film, a tape, a strip, a panel, or a cord. Alternatively, the metal-resin composite molding may have a three-dimensional shape like, for example, a cylinder, a column, a sphere, a block, a tube, a pipe, pits and projections, a film, fibers, a fabric, or a bundle.

The metal-resin composite molding having the above structure is manufactured through the following treatments (1) to (4).

### (1) Surface Treatment of Metal Portion

The surface of the metal portion is contaminated with foreign substances such as machining oil, oxides, or hydroxides. These foreign substances inhibit adhesion between the metal portion and resin portion. In order to remove the foreign substances from the metal portion, the metal portion is subjected to surface treatment. The surface treatment is conducted by, for example, rubbing the surface of the metal portion with polishing paper such as sandpaper, thereby removing oil components. Alternatively, the metal portion may be immersed in an acid such as hydrochloric acid (when the metal portion is composed of aluminum) or sulfuric acid (when the metal portion is composed of copper), thereby removing foreign substances through etching. Further, the metal portion may be degreased by immersion in an aqueous solution of a strong alkaline degreasing agent.

### (2) ITRO Treatment (Silicification Flame Treatment) for Applying Silanol Groups to the Surface of the Metal Portion

ITRO treatment is one of surface modification techniques. In ITRO treatment, a modifier compound containing silane atoms is vaporized under heating to obtain a fuel gas. The fuel gas is mixed with a flammable gas and burned, and the produced flame is blown on the metal portion. As a result of this, the surface of the metal portion is decomposed by flame heat, and a silicon dioxide layer is formed on the surface of the metal portion.

The modifier compound is composed an alkylsilane compound and/or an alkoxysilane compound. Examples of the alkylsilane compound include tetramethylsilane, tetraethylsilane, 1,2-dichlorotetramethylsilane, 1,2-diphenyl tetramethylsilane, 1,2-dichlorotetraethylsilane, 1,2-diphenyl tetraethylsilane, 1,2,3-trichlorotetramethylsilane, 1,2,3-triphenyltetramethylsilane, dimethyldiethyltetrasilane. These compounds may be used alone or in combination of two or more thereof.

The boiling point of the modifier compound is preferably from 10° C. to 100° C. under atmospheric pressure. If the boiling point of the modifier compound is lower than 10° C., the compound is highly volatile and hard to handle. If the boiling point of the modifier compound is higher than 100° C., miscibility of the modifier compound with a flammable gas or combustion improver markedly deteriorates, so that the modifier compound tends to cause imperfect combustion. As a result of this, the surface of the metal portion may be unevenly modified, or the modification effect may not last over a long period.

Most alkylsilane compounds have a low boiling point, so that they are readily vaporized under heating to be evenly mixed with a flammable gas. Tetramethylsilane and tetraethylsilane are readily mixed with a flammable gas because they have particularly low boiling points, so that they are preferable modifier compounds. In addition, halogenated silane compounds such as 1,2-dichlorotetramethylsilane are preferable because they are particularly excellent in the surface modification effect. On the other hand, most alkoxysilane compounds have a high boiling point due to their ester structure. However, an alkoxysilane compound has better surface modification effect on the metal portion as long as its boiling point is within the range of 10° C. to 100° C. The boiling point can be controlled by mixing a low-boiling alkylsilane compound with a high-boiling alkoxysilane compound.

The fuel gas may contain a modification aid. The modification aid is preferably at least one compound selected from the group consisting of alkylsilane compounds, alkoxysilane compounds, alkyltitanium compounds, alkoxytitanium compounds, alkylaluminum compounds, and alkoxyaluminum compounds having a boiling point of 100° C. or higher. Even if the compound has a slightly high boiling point, poor handleability of a fuel gas due to a low boiling point of the modifier compound is improved through the addition of a modification aid having excellent compatibility with the modifier compound. In addition, the surface modification effect on the metal portion is further enhanced.

The flammable gas facilitates control of the flame temperature. Examples of the flammable gas include hydrocarbon gases such as a propane gas and a natural gas, and hydrogen, oxygen, and air. Before a fuel gas is mixed with a flammable gas, a carrier gas may be added to the fuel gas. In this way, even if an unwieldy modifier compound having a relatively high molecular weight is used, the modifier compound is evenly mixed with a carrier gas, and then evenly mixed with a flammable gas. As a result of this, the modifier compound becomes readily flammable, and the surface of the metal portion is evenly and sufficiently modified. The carrier gas is preferably the same gas as the flammable gas. Examples of the carrier gas include air, oxygen, and hydrocarbons such as a propane gas and a natural gas.

The flame temperature is preferably controlled within the range of 500° C. to 1500° C. If the temperature is lower than 500° C., it becomes difficult to effectively prevent the imperfect combustion of the modifier compound. On the other hand, if the temperature is higher than 1500° C., the metal portion to be subjected to the surface modification may be deformed or degraded by heat, so that the kind of usable metal is limited. The flame temperature is controlled according to the kind and flow rate of the combustion gas to be used, and the kind and amount of the modifier compound.

The flame is blown on the metal portion preferably for 0.1 to 100 seconds. If the period is shorter than 0.1 seconds, the modification effect by the modifier compound may not be evenly achieved. On the other hand, if the period is longer than 100 seconds, the metal portion may be deformed or degraded by heat, so that the kind of usable metal is limited.

Through the ITRO treatment, nanoparticles composed mainly of silicon dioxide (SiO₂) are formed on the surface of the metal portion. According to the analysis of the nanoparticles by X-ray photoemission spectroscopy (XPS), the silicon dioxide is not homogeneous but contains excessive oxygen. The fact suggests that the nanoparticles partially have silanol group (SiOH) structures. In addition, the nanoparticles are hydrophilic. This is likely due to hydroxy groups (OH). The average particle diameter of the nanoparticles is about 10 nm. Therefore, the nanoparticles will not be affected by the molecular motion of the polymer, and will not enter into the metal portion over time. Accordingly, the modification effect of the modifier compound is sustained over a long time.

### (3) Addition of Adhesive Modifier to Base Material

The base material and adhesive modifier are evenly molten and kneaded with, for example, a single or twin screw extruder at a predetermined temperature, and then granulated. The base material and adhesive modifier are molten at the predetermined temperature. Through the melting and kneading, the adhesive modifier is evenly dispersed in the base material.

### (4) Molding of Composite Molding

The metal portion subjected to ITRO treatment is arranged as an insert in a mold for resin molding. The granulated molding material is mounted on the metal portion in the mold. Thereafter, the mold is closed and subjected to pressurization and heating. As a result of this, the molding material in the mold is heated and molten. Then, the molten molding material is cured thereby forming the molding material into a resin portion. At the interface between the metal portion and resin portion, the silanol groups on the surface of the metal portion and the adhesive functional groups in the molding material attract each other. As a result of this, the resin portion and metal portion are bonded together to produce a metal-resin composite molding.

As described above, the adhesion between the metal portion and resin portion requires no adhesive, and thus requires no treatment for applying an adhesive to the metal portion or drying an applied adhesive. In addition, molding of the resin portion and adhesion between the resin portion and metal portion are conducted simultaneously, so that the manufacturing process is simplified in comparison with the case where these components are bonded together with an adhesive.

During molding, annealing treatment may be conducted thereby removing distortions created during molding, and accelerating crystallization of the base material. During the annealing treatment, molding is conducted with the surface temperature of the mold kept at the crystallization temperature of the base material. The annealing treatment is conducted through the control of the surface temperature of the mold concurrently with resin molding in the mold. This is referred to as in-mold annealing. Alternatively, the annealing treatment may be conducted after resin molding. For example, the annealing treatment may be conducted after resin molding using a dryer such as a vacuum dryer.

The resin portion may be molded by methods other than the compression molding method. For example, the resin portion may be molded by an injection molding method. Under the compression molding method, a molding material is molten and molded in a mold. In contrast, under the injection molding method, a molding material is molten outside a mold, and then the molten molding material is injected into the mold and formed into a predetermined shape. Under the both molding methods, the metal portion is arranged as an insert in a mold for resin molding, and the molding of the resin portion and the adhesion between the resin portion and metal portion are conducted at the same time.

In the metal-resin composite molding obtained as described above, the metal portion and resin portion are bonded together at the interface between them with a strength equivalent to that achieved by the adhesion with an adhesive. Accordingly, the metal portion will not be easily peeled off from the resin portion.

The metal-resin composite molding is useful for various applications such as electric and electronic components, building and civil engineering materials, automobile parts, agricultural materials, packaging materials, clothes, and daily necessities. Examples of automobile parts include interior and exterior components, and sealing parts for sealing engine cooling water or engine oil. The metal-resin composite molding of the present invention is also useful as an electrode sealing material for a battery in a hybrid vehicle equipped with an engine and an electric motor as power sources.

The embodiments of the present invention are further described with reference to examples and comparative examples.

### EXAMPLES 1 TO 12 AND COMPARATIVE EXAMPLES 1 TO 9

The metal portion was an aluminum (A1050) plate having a length of 75 mm, a width of 25 mm, and a thickness of 2 mm.

The metal portion was subjected to surface treatment as described below. Firstly, the surface of the metal portion was rubbed with sandpaper having a particle size of #1000 thereby removing oil components from the surface of the metal portion. Subsequently, the metal portion was immersed and etched in hydrochloric acid at 23° C. for 1 minute. Furthermore, the metal portion was immersed and degreased in an aqueous solution of a strong alkali degreasing agent (FC-E2001, manufactured by Nihon Parkerizing Co., Ltd.) at 70° C. for 1 minute. Thereafter, the degreased metal portion was subjected to measurements.

As shown in Table 1, in all of Examples 1 to 12 and Comparative Examples 1 to 5, the surfaces of the metal portions were subjected to ITRO treatment using an ITRO treatment system manufactured by Isimat Japan Ltd. The ITRO treatment conditions were as follows: compressed air flow rate, 80 NL/minute; gas flow rate, 3 NL/minute; ITRO solution flow rate, 2 NL/minute; and application speed, 15 cm/second. In Table 1, “O” indicates that the surface was subjected to ITRO treatment, and “x” indicates that the surface was not subjected to ITRO treatment.

The base materials and adhesive modifiers used in Examples 1 to 12 and Comparative Examples 1 to 9 are listed below Table 1 (*1 to *8). They were charged into LABO PLASTOMILL KF70V2 manufactured by Toyo Seiki Seisaku-sho, Ltd.

In Table 1, “modified PE/PS” listed in the field of adhesive modifier is a graft copolymer containing polyethylene as the main chain and a styrenic polymer as the side chain, and the polyethylene main chain is modified with glycidyl dimethacrylate (GMA), and has glycidyl groups as the adhesive functional groups. In the following description, the copolymer is simply referred to as “modified PE/PS”. The modified PE (*7) is a polyethylene modified with glycidyl methacrylate, and the modified PE (*8) is a polyethylene modified with maleic anhydride at a modification rate of 10%.

LABO PLASTOMILL is a tabletop test apparatus for evaluating kneading properties and extrusion properties of a very small amount of a sample synthesized at a laboratory level. Using the test apparatus, the base material and adhesive modifier were molten and kneaded for 5 minutes at a melting temperature of the base material (PPS: 320° C., PA 12: 290° C., PA 66: 300° C., and PBT: 260° C.). Subsequently, the metal portion was arranged as an insert in a mold, and the base material was compressed and molded at the above-described temperature. During the resin molding, annealing treatment was conducted under the following conditions according to the kind of the base material. More specifically, when the base material was polyphenylene sulfide (PPS), resin molding was conducted with the mold surface temperature kept at 150° C. for 3 hours. When the base material was polyamide 12 (PA 12), polyamide 66 (PA 66), or polybutylene terephthalate (PBT), resin molding was conducted with the mold surface temperature kept at 100° C. for 3 hours.

Through the above-described resin molding, plate-shaped resin portions having a length of 75 mm, a width of 15 mm, and a thickness of 3 mm were formed. Each of the resin portion was bonded to the surface of a metal portion with a surface having a length of 12 mm and a width of 15 mm (surface area: 180 mm²). In this way, the metal portions and resin portions were bonded together to make test pieces. The tensile shear strength of these test pieces was measured twice according to JIS K 6850 (tensile shear strength test method for adhesive). The tensile shear strength is a tensile load per unit area necessary for destroying the bonded portion when the both ends of the test piece are pulled in parallel to the bonded interface at a constant tension rate (10 mm/minute). The higher the tensile shear strength is, the stronger the adhesion between the metal portion and resin portion is. The measurement results are shown in Table 1.

In Table 1, the term “peeling mode” refers to the mode of peeling when the metal portion is peeled off from the resin portion. “Interfacial peeling” mode refers to the state where the bonded portion is exclusively destroyed and peeled off with no corruption of the resin portion including the base material. The term “base material collapse” refers to the collapse of the resin portion including the base material, which occurs when the stress destroying the resin portion is smaller than the cohesive force and interface adhesiveness of the adhesive.

TABLE 1
Metal: Aluminum (A1050)

| | | Comparative Examples | | | | | | | | | Examples | |
|---|---|---|---|---|---|---|---|---|---|---|---|---|
| | | 1 | 2 | 3 | 4 | 5 | 6 | 7 | 8 | 9 | 1 | 2 |
| Base | PPS (linear type) (*1) | 100 | | | | | 80 | | | | 90 | 80 |
| Material | PPS (crosslinked type) (*2) | | 100 | | | | | | | | | |
| | PA12 (*3) | | | 100 | | | | 80 | | | | |
| | PA66 (*4) | | | | 100 | | | | 80 | | | |
| | PBT (*5) | | | | | 100 | | | | 80 | | |
| Adhesive | Modified PE/PS (*6) | | | | | | 20 | 20 | 20 | 20 | 10 | 20 |
| Modifier | Modified PE (*7) | | | | | | | | | | | |
| | Modified PE (*8) | | | | | | | | | | | |
| | Functional group content | 0 | 0 | 0 | 0 | 0 | 2 | 2 | 2 | 2 | 1 | 2 |
| | (wt %) | | | | | | | | | | | |
| Metal | Metal ITRO treatment (*9) | ◯ | ◯ | ◯ | ◯ | ◯ | X | X | X | X | ◯ | ◯ |
| Physical | Tensile shear strength [MPa] | 0.2 | 0.4 | 0.3 | 0.4 | 0.3 | 1.2 | 1.0 | 1.0 | 1.1 | 6.5 | 10.3 |

| | | | |
|---|---|---|---|
| Properties | Peeling mode | Interfacial peeling | Base |
| | | | material |
| | | | collapse |

| | | Examples | | | | | | | | | |
|---|---|---|---|---|---|---|---|---|---|---|---|
| | | 3 | 4 | 5 | 6 | 7 | 8 | 9 | 10 | 11 | 12 |
| Base | PPS (linear type) (*1) | 70 | 80 | | 80 | | | | | | |
| Material | PPS (crosslinked type) (*2) | | | 80 | | | | | | | |
| | PA12 (*3) | | | | | 80 | 80 | | | | |
| | PA66 (*4) | | | | | | | 80 | 80 | | |
| | PBT (*5) | | | | | | | | | 80 | 80 |
| Adhesive | Modified PE/PS (*6) | 30 | | 20 | | 20 | | 20 | | 20 | |
| Modifier | Modified PE (*7) | | 20 | | | | | | | | |
| | Modified PE (*8) | | | | 20 | | 20 | | 20 | | 20 |
| | Functional group content | 3 | 2 | 2 | 2 | 2 | 2 | 2 | 2 | 2 | 2 |
| | (wt %) | | | | | | | | | | |
| Metal | Metal ITRO treatment (*9) | ◯ | ◯ | ◯ | ◯ | ◯ | ◯ | ◯ | ◯ | ◯ | ◯ |
| Physical | Tensile shear strength [MPa] | 7.3 | 10.3 | 9.9 | 7.9 | 7.5 | 6.3 | 7.3 | 6.8 | 7.8 | 6.3 |

| | | |
|---|---|---|
| Properties | Peeling mode | Base material collapse |

(*1) A900 manufactured by Toray Industries, Inc.
(*2) A504X manufactured by Toray Industries, Inc.
(*3) Polyamide 6: UBESTA 3020 manufactured by Ube Industries, Ltd.
(*4) Polyamide 66: UBE Nylon 2020 manufactured by Ube Industries, Ltd.
(*5) TORAYCON 1401 manufactured by Toray Industries, Inc.
(*6) MODIPER A4100 manufactured by Nof Corporation (GMA-modified)
(*7) BONDFAST E manufactured by Sumitomo Chemical Co., Ltd. (GMA-modified) GMA: glycidyldimethacrylate
(*8) Manufactured by Japan Polyethylene Corporation (maleic anhydride-modified)
(*9) Silanol groups were applied to the metal surface.

The results of Comparative Examples 1 to 9 shown in Table 1 suggest the followings.

(A) The metal-resin composite molding of Comparative Examples 1 to 5, which were composed of a base material containing no adhesive modifier and an aluminum metal portion subjected to ITRO treatment, had a tensile shear strength of 0.2 to 0.4 MPa irrespective of the kind of the base material. The fact suggests that a high tensile shear strength cannot be achieved with an untreated base material in spite of the presence of silanol groups on the surface of the metal portion.

(B) The metal-resin composite molding of Comparative Examples 6 to 9, which were composed of a base material containing modified PE/PS as the adhesive modifier and an aluminum metal portion without ITRO treatment, had a tensile shear strength of 1.0 to 1.2 MPa irrespective of the kind of the base material. The fact indicates the adhesiveness between the base material containing an adhesive modifier having adhesive functional groups and the metal portion without ITRO treatment. However, the tensile shear strengths achieved in Comparative Examples 6 to 9 were higher than those achieved in Comparative Examples 1 to 5, but not at a sufficient level.

(C) The tensile shear strengths achieved in Comparative Examples 1 to 5 and Comparative Examples 6 to 9 were little different, regardless whether the base material is polyphenylene sulfide, polyamide 12, polyamide 66, or polybutylene terephthalate. The tensile shear strengths achieved in Comparative Examples 1 to 5 were from 0.2 to 0.4 MPa, and those in Comparative Examples 6 to 9 were from 1.0 to 1.2 MPa. In Comparative Examples 1 to 9, the metal portion was peeled off from the resin portion at the interface between them. The fact suggests that the base material is scarcely involved with improvement of the adhesiveness, and the surface of the metal portion subjected to ITRO treatment and the adhesive functional groups in the adhesive modifier substantially contribute to the improvement of the adhesiveness.

The followings are suggested by the comparison of the results of Comparative Examples 1 to 9 and Examples 1 to 12 shown in Table 1.

The metal-resin composite molding of Examples 1 to 12, which were composed of a base material containing an adhesive modifier having adhesive functional groups and an aluminum metal portion subjected to ITRO treatment, had a tensile shear strength of 6.3 to 10.3 MPa irrespective of the kind of the base material and adhesive modifier. These values are larger than the tensile shear strengths (0.2 to 1.2 MPa) of the metal-resin composite moldings of Comparative Examples 1 to 9. The test pieces of Examples 1 to 12 were combinations of Comparative Examples 1 to 5 and Comparative Examples 6 to 9. However, the tensile shear strength of the test pieces of Examples 1 to 12 were markedly higher than the simple combinations of the values of Comparative Examples 1 to 5 and Comparative Examples 6 to 9.

More specifically, Example 2 is different from Comparative Example 6 only in that it is composed of a metal portion having an ITRO-treated surface. However, in comparison between Example 2 and Comparative Example 6, the tensile shear strength markedly increased from 1.2 MPa to 10.3 MPa.

Example 7 is different from Comparative Example 7 only in that it is composed of a metal portion having an ITRO-treated surface. However, in comparison between Example 7 and Comparative Example 7, the tensile shear strength markedly increased from 1.0 MPa to 7.5 MPa.

Example 9 is different from Comparative Example 8 only in that it is composed of a metal portion having an ITRO-treated surface. However, in comparison between Example 9 and Comparative Example 8, the tensile shear strength markedly increased from 1.0 MPa to 7.3 MPa.

Example 11 is different from Comparative Example 9 only in that it is composed of a metal portion having an ITRO-treated surface. However, in comparison between Example 11 and Comparative Example 9, the tensile shear strength markedly increased from 1.1 MPa to 7.8 MPa.

These facts suggest that the enhancement of the tensile shear strength is largely attributable to the use of the resin portion containing an adhesive modifier, and the metal portion having silanol groups as a result of ITRO treatment.

Examples 1, 2, 3, 4, and 6 are different from Comparative Example 1 only in that they are composed of a base material containing an adhesive modifier. However, in comparison between Examples 1 to 4, 6 and Comparative Example 1, the tensile shear strength markedly increased from 0.2 MPa to 6.5 to 10.3 MPa.

Example 5 is different from Comparative Example 2 only in that it is composed of a base material containing an adhesive modifier. However, in comparison between Example 5 and Comparative Example 2, the tensile shear strength markedly increased from 0.4 MPa to 9.9 MPa.

Examples 7 and 8 are different from Comparative Example 3 only in that they are composed of a base material containing an adhesive modifier. However, in comparison between Examples 7, 8 and Comparative Example 3, the tensile shear strength markedly increased from 0.3 MPa to 6.3 to 7.5 MPa.

Examples 9 and 10 are different from Comparative Example 4 only in that they are composed of a base material containing an adhesive modifier. However, in comparison between Examples 9, 10 and Comparative Example 4, the tensile shear strength markedly increased from 0.4 MPa to 6.8 to 7.3 MPa.

Examples 11 and 12 are different from Comparative Example 5 only in that they are composed of a base material containing an adhesive modifier. However, in comparison between Examples 11, 12, and Comparative Example 5, the tensile shear strength markedly increased from 0.3 MPa to 6.3 to 7.8 MPa.

These facts suggest that the enhancement of the tensile shear strength is largely attributable to the use of the metal portion having silanol groups on its surface as a result of ITRO treatment, and the resin portion containing an adhesive modifier in the base material.

As described above, in the metal-resin composite molding, the tensile shear strength is markedly enhanced likely due to the interaction between the silanol groups on the ITRO-treated surface of the metal portion and the adhesive modifier, specifically the adhesive functional group, contained in the resin portion. It is also distinctive that various kinds of synthetic resins and adhesive modifiers are usable in the resin portion.

The results of Examples 1 to 12 suggest the followings.

(I) Examples 1 and 3 are different from Example 2 in the proportions of the base material (linear polyphenylene sulfide) and adhesive modifier (modified PE/PS). Examples 1 and 3 achieved high tensile shear strengths (6.5 MPa, 7.3 MPa), though not as high as Example 2 (10.3 MPa). These facts suggest that a high tensile shear strength is achieved when the content of the adhesive modifier (modified PE/PS) is within a specified range with reference to the base material, and at least in the range of 10 to 30% by weight.

(II) Examples 4 and 6 are different Example 2 in the kind of the adhesive modifier contained in the base material (linear polyphenylene sulfide). The proportions of the base material and adhesive modifier are the same as Example 2. Examples 4 and 6 also achieved as high tensile shear strengths (10.3 MPa, 7.9 MPa) as Example 2 (10.3 MPa). These facts suggest that the kind of the adhesive modifier is not greatly involved with the increase of the tensile shear strength.

(III) Examples 5, 7, 9, and 11 are different Example 2 in the kind of the base material. Example 5, 7, 9, and 11 achieved high tensile shear strengths (7.3 to 9.9 MPa), though not as high as Example 2 (10.3 MPa). These facts suggest that the kind of the base material is not greatly involved with the increase of the tensile shear strength.

(IV) Examples 6, 8, 10, and 12 are different from each other in the kind of the base material, on the precondition that polyethylene modified with maleic anhydride is used as the adhesive modifier. The proportions of the base material and adhesive modifier are the same among them. However, the tensile shear strengths of Examples 6, 8, 10, and 12 were as high as 6.3 to 7.9 MPa, and the difference in the tensile shear strength according to the kind of the base material was small. These facts suggest that the kind of the base material is not greatly involved with the increase of the tensile shear strength.

(V) Among Examples 1 to 12, Examples 2, 4, and 5 achieved slightly higher tensile shear strengths than other examples. However, the result is not due to the specific combination between a base material and an adhesive modifier, but that the combination of the base material and adhesive modifier in Examples 1 and 3 is the same as Example 2, but the tensile shear strengths of Examples 1 and 3 are not as high as Example 2.

(VI) Examples 1 to 12 are different from Comparative Examples 1 to 9 in that the base material collapsed during the measurement of the tensile shear strength. The fact suggests that the adhesive modifier may influence the strength of the base material.

### EXAMPLES 21 TO 32 AND COMPARATIVE EXAMPLE 11 TO 19

The metal portion was composed of copper (C1100) in place of aluminum (A1050). In addition, the base material and adhesive modifier were those listed in Table 2. Test pieces of metal-resin composite moldings were made and subjected to tensile shear strength in the same manner as Examples 1 to 12 and Comparative Examples 1 to 9. The measurement results are shown at the bottom of Table 2.

Examples 21 to 32 correspond to Examples 1 to 12, and Comparative Examples 11 to 19 correspond to Comparative Examples 1 to 9, respectively.

TABLE 2
Metal: Cu (C1100)

| | | Comparative Examples | | | | | | | | | Examples | |
|---|---|---|---|---|---|---|---|---|---|---|---|---|
| | | 11 | 12 | 13 | 14 | 15 | 16 | 17 | 18 | 19 | 21 | 22 |
| Base | PPS (linear type) (*1) | 100 | | | | | 80 | | | | 90 | 80 |
| Material | PPS (crosslinked type) (*2) | | 100 | | | | | | | | | |
| | PA12 (*3) | | | 100 | | | | 80 | | | | |
| | PA66 (*4) | | | | 100 | | | | 80 | | | |
| | PBT (*5) | | | | | 100 | | | | 80 | | |
| Adhesive | Modified PE/PS (*6) | | | | | | 20 | 20 | 20 | 20 | 10 | 20 |
| Modifier | Modified PE (*7) | | | | | | | | | | | |
| | Modified PE (*8) | | | | | | | | | | | |
| | Functional group content | 0 | 0 | 0 | 0 | 0 | 2 | 2 | 2 | 2 | 1 | 2 |
| | (wt %) | | | | | | | | | | | |
| Metal | Metal ITRO treatment (*9) | ◯ | ◯ | ◯ | ◯ | ◯ | X | X | X | X | ◯ | ◯ |
| Physical | Tensile shear strength [MPa] | 0.1 | 0.3 | 0.1 | 0.2 | 0.3 | 1.0 | 0.8 | 1.1 | 0.9 | 4.2 | 6.3 |

| | | | |
|---|---|---|---|
| Properties | Peeling mode | Interfacial peeling | Base |
| | | | material |
| | | | collapse |

| | | Examples | | | | | | | | | |
|---|---|---|---|---|---|---|---|---|---|---|---|
| | | 23 | 24 | 25 | 26 | 27 | 28 | 29 | 30 | 31 | 32 |
| Base | PPS (linear type) (*1) | 70 | 80 | | 92 | | | | | | |
| Material | PPS (crosslinked type) (*2) | | | 80 | | | | | | | |
| | PA12 (*3) | | | | | 80 | 92 | | | | |
| | PA66 (*4) | | | | | | | 80 | 92 | | |
| | PBT (*5) | | | | | | | | | 80 | 92 |
| Adhesive | Modified PE/PS (*6) | 30 | | 20 | | 20 | | 20 | | 20 | |
| Modifier | Modified PE (*7) | | 20 | | | | | | | | |
| | Modified PE (*8) | | | | 8 | | 8 | | 8 | | 8 |
| | Functional group content | 3 | 2 | 2 | 2 | 2 | 2 | 2 | 2 | 2 | 2 |
| | (wt %) | | | | | | | | | | |
| Metal | Metal ITRO treatment (*9) | ◯ | ◯ | ◯ | ◯ | ◯ | ◯ | ◯ | ◯ | ◯ | ◯ |
| Physical | Tensile shear strength [MPa] | 5.8 | 8.9 | 10.5 | 5.8 | 5.8 | 5.2 | 6.0 | 6.3 | 6.8 | 6.0 |

| | | |
|---|---|---|
| Properties | Peeling mode | Base material collapse |

When the metal portion was composed of copper, the same tendency as that of aluminum described above (Table 1) was observed, except the following facts.

(α) When the metal portion was composed of copper, the tensile shear strength was slightly lower than that in the case using aluminum, except some comparative examples and some examples (see (β) to (δ)).

(β) Comparative Example 15 including polybutylene terephthalate as the base material achieved the same tensile shear strength (0.3 MPa) as Comparative Example 5 under the same conditions.

(γ) Comparative Example 18 including polyamide 66 (PA 66) as the base material and modified PE/PS as the adhesive modifier achieved a slightly higher tensile shear strength than Comparative Example 8 under the same conditions (from 1.0 MPa to 1.1 MPa).

(δ) Example 25 including crosslinked polyphenylene sulfide as the base material and modified PE/PS as the adhesive modifier achieved a slightly higher tensile shear strength than Example 5 under the same conditions (from 9.9 MPa to 10.5 MPa).

1. A metal-resin composite molding composed of a metal portion formed from a metal bonded to a resin portion formed from a synthetic resin,
the surface of the metal portion having silanol groups,
the synthetic resin containing an adhesive modifier having adhesive functional groups interacting with the silanol groups, and
the metal portion and the resin portion being bonded together by the interaction between the silanol groups and the adhesive functional groups.

2. The metal-resin composite molding according to claim 1, wherein the adhesive functional groups are epoxy groups.

3. The metal-resin composite molding according to claim 1, wherein the content of the adhesive functional groups in the resin portion is from 0.5 to 5% by weight.

4. The metal-resin composite molding according to claim 2, wherein the adhesive modifier is a copolymer of polyethylene or polyethylene having epoxy groups as the adhesive functional groups.

5. The metal-resin composite molding according to claim 1, wherein the content of the adhesive modifier in the resin portion is from 5 to 40% by weight.

6. The metal-resin composite molding according to claim 1, wherein the adhesive modifier is polyethylene modified with maleic anhydride.

7. The metal-resin composite molding according to claim 1, wherein the synthetic resin is an engineering plastic.

8. The metal-resin composite molding according to claim 7, wherein the engineering plastic is polyphenylene sulfide, polyamide, or polybutylene terephthalate.

9. A method for manufacturing a composite molding composed of a metal portion formed from a metal bonded to a resin portion formed from a synthetic resin, comprising:
applying silanol groups to the surface of the metal portion;
adding an adhesive modifier having adhesive functional groups interacting with the silanol groups to the synthetic resin thereby producing a molding material; and
arranging the metal portion as an insert in a mold for resin molding, melting and forming the molding material in the mold into the resin portion, and at the same time bonding the resin portion to the metal portion through the interaction between the silanol groups and the adhesive functional groups.

10. The method according to claim 9, wherein the applying silanol groups includes blowing a flame of a fuel gas to the surface of the metal portion, the fuel gas being composed of a modifier compound containing silane atoms.

11. The method according to claim 10, wherein the modifier compound is composed of an alkylsilane compound and/or an alkoxysilane compound.
